(19) United States
(12) Patent Application Publication
(10) Pub. No.: US 2008/0043157 A1
(43) Pub. Date: Feb. 21, 2008

(54) Three dimensional projection system for the display of information

(76) Inventor: Brad G. Jones, Beverly Hills, CA (US)

Correspondence Address: STETINA BRUNDA GARRED & BRUCKER, 75 ENTERPRISE, SUITE 250, ALISO VIEJO, CA, 92656, US

(21) Appl. No.: 11/881,929

(22) Filed: Jul. 30, 2007

Related U.S. Application Data
(60) Provisional application No. 60/837,680, filed on Aug. 15, 2006.

(51) Int. Cl. H04N 9/31; G03B 21/14

(52) U.S. Cl. 348/744; 353/119; 348/E05.137

(57) ABSTRACT

An image projection system for displaying information for observation by at least one viewer of an event by projecting the information onto a venue structure or a game associated object, that comprises a projection device; an image projected by the projection device for observation by the viewer, and a projection surface that receives the image The image may be any type of communication such as an advertisement of a product or service or any other type of information that can be communicated to an observer of the image. The image is projected onto either an existing component of a venue structure or an event associated object.

### CROSS-REFERENCE TO RELATED APPLICATIONS

This application claims the benefit of U.S. Provisional Application No. 60/837,680 filed on Aug. 15, 2006.

### STATEMENT RE: FEDERALLY SPONSORED RESEARCH/DEVELOPMENT

Not Applicable

### BACKGROUND

The present invention relates generally to a method and system of displaying information to a viewer of a venue event such as a sport competition, a show or a concert. More specifically, the present invention relates to a method and system of displaying an advertising or marketing presentation or other type of communication to a viewer of an event by projecting the same onto either an existing component of the venue structure or a game associated object.

Sponsor advertisements are a traditional and common component of almost any venue event, including sport events, concerts and festivals. An example of one particular advertisement may take the form of a coupon on the back of an admission ticket to the venue, which may be redeemable at the place of business of the sponsor. An advertisement may also include information printed on a page in a souvenir book, a pamphlet or a flyer or an advertisement may be placed on a strategically located billboard or sign.

Large stadium events, such as football games, provide a great opportunity to reach an intended segment of the population. Typically, the individuals attending the event share a common interest in the subject of the event. Additionally, these individuals may share a common interest in one or more products or services that may be associated with the event. Sponsors and other businesses are usually attracted to an event that is associated in some manner with the types of products or services they are trying to sell. The opportunities for a sponsor to promote its products at a venue event are infinite as both the venue and the venue event inherently provides unlimited opportunities for a sponsor or other business to reach its target audience. For example, football games are likely to generate an interest in sports apparel and athletic footwear, sports equipment, sports television and radio broadcast stations, alcoholic and non-alcoholic beverages and certain types of food.

Ultimately, the targeted consumer is so inundated with marketing and advertising schemes that he or she tends to ignore, either intentionally or unintentionally, much of the information. Further, each viewer may not be able to observe all of the advertisements associated with the event depending on the type and location of the event and where the viewer is situated. For example, large sport venue events, such as football games, are often simultaneously broadcast on television and radio. In particular, large sums of money are paid by businesses to obtain a commercial spot during the annual football NFL Super Bowl. Commercials are broadcast during the television station breaks which provide a method of reaching a potential consumer. Generally, a sponsoring business pays to obtain time slots of varying time durations during which the sponsor's commercial is shown. Due to the reach of the television broadcast and the size of the audience, a business tries to make its commercials sufficiently entertaining so that the viewing public will want to watch them. However, only the remote viewers have the opportunity to observe the commercial advertisements. Moreover, developments in technology exist that enable a remote viewer to record a program for later viewing and then bypass portions of a program that they do not wish to view. Thus, a remote viewer can fast-forward or otherwise advance through the commercials if that viewer chooses not to observe the same.

A number of proposed solutions exist in the prior art that attempt to provide a sponsoring business with the opportunity to reach its potential consumer targets during an event. For example, DiCicco, et al., U.S. Pat. No. 5,892,554, issued Apr. 6, 1999, discloses a system and method for inserting both static and dynamic images into a live video broadcast. Specifically, DiCicco involves a multi-step process to automatically select and track natural landmarks and other reference points to serve as an origin point for the insertion of images. Using the process disclosed by DiCicco, a real-time virtual image in the form of an advertisement or logo can be inserted anywhere and at any time within the television broadcast of an event. For example, an advertisement or logo can be virtually inserted during a baseball game at locations such as behind home plate or over empty seats of a relatively empty stadium section. However, any such insertions are observable by only the remote viewers of the event. Members of the attending audience and most other viewers present inside the venue do not have the capability to observe this information.

Various companies have recently attempted to embed their messages in the sport itself rather than airing television commercials in connection with a sporting event as it is remotely viewed. One company in particular has adapted a conventional field goal net, which is used during college football broadcasts. The net carries an advertisement in the form of the name and logo of the company permanently printed thereon. The field goal net is placed in one end zone of a stadium for observation by the event attendees. Television networks show the field goal nets during the television broadcast so that remote viewers, in addition to the event attendees, can observe the advertisements contained thereon. However, only the advertisement of a single company can be placed on the field goal net due to the permanent nature of printing the advertisement onto the field goal net. As a result, only one sponsor per event can typically utilize the opportunity to reach potential consumers unless the field goal net is removed and replaced with a different net.

A need therefore exists for a novel way to present various types of information to a viewer of an event that utilizes existing venue structure or other game-associated equipment. The information should not be permanently affixed to the venue structure or game-associated equipment to allow the information to be easily altered, modified or changed. Further, multiple sponsors should be able to present information with minor adaptations. The viewers at the venue and the remote viewers, if the event is broadcast on television should be able to observe the information.

### BRIEF SUMMARY

An image projection system for displaying information for observation by at least one viewer of an event in a venue by projecting the information onto a venue structure or a game associated object is disclosed. The image projection system comprises a projection device; an image projected by the projection device for observation by the viewer, and at least one projection surface on which the image is projected. The projection device may be one of a rear projector, a front projector and an overhead projector. The projection device technology may include a liquid crystal display, a laser projection display, a cathode ray tube, a digital light processing, a liquid crystal on silicone device, a light emitting diode device and a plasma device. The image may be a three dimensional image, such as a hologram and the image may be either static or dynamic. The projection surface may be a goal net or the projection surface may be part of the venue structure.

The image suspension may further include a suspension cable system from which the projection surface is suspended, wherein the suspension cable system further comprises at least one cable that is substantially coextensive with the perimeter of the top of the venue structure. The image projection system may further include a housing structure that encloses the projection surface in a stowed position and supports the projection surface in an extended position. The system may further include a drive motor operative to extend the projection surface to an extended position and retract the projection surface to a stowed position and a power source operative to power the drive motor. The projection surface may be a weather projection screen, such as a sunshade.

One advantage of the disclosed method and system is that the image may be observed by any viewer of the event such as a remote viewer, an event attendee or any other individual who may be within a viewable range of the image. Another advantage is that the image does not have a permanent nature so more than one sponsor may take advantage of the opportunity to display information to a targeted audience.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates an embodiment of the image projection system that shows the display of information in the form of a projected image on the surface of a field goal net.

FIG. 2 illustrates another embodiment of the image projection system having a retractable projection surface attached to a suspension cable system, with the projection surface shown in an extended position.

FIG. 3 is another view of the embodiment shown in FIG. 2, with the projection surface shown in a stowed position.

FIG. 4 illustrates a housing of the projection surface of FIG. 2 with a projection surface shown in an extended position.

FIG. 5 is a perspective view of another embodiment of the image projection system having a projection surface that is affixed to a venue structure.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for utilizing the invention. It is to be understood, however, that the same or equivalent functions and sequences may be accomplished by different embodiments and that they are intended to be encompassed within the scope of the invention.

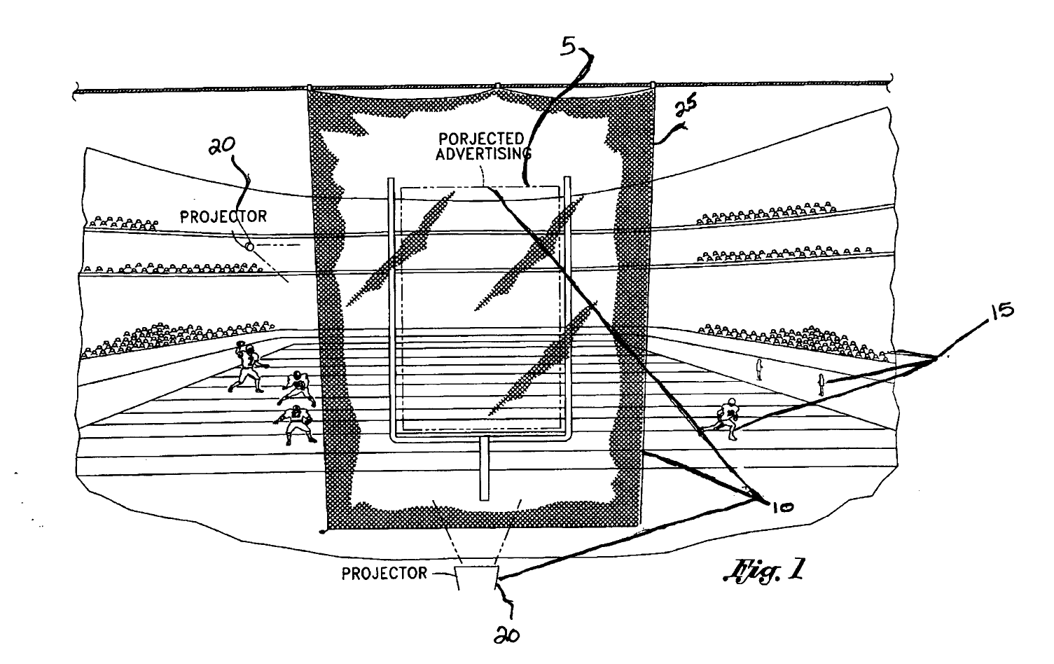

FIG. 1 illustrates a typical scene during a football game in a stadium as viewed from someone seated behind a field goal post. The football players of both teams are engaged in playing the game; the players, coaches and other officials are on the side lines and a crowd has filled the venue to watch the event. FIG. 1 shows an image projection system 10 for projecting and displaying information in the form of an image 5 to at least one viewer 15 of a venue event. Image projection system 10 is comprised of a projection device 20, a projection surface 25 and an image 5, which is projected to at least one viewer 15. The image projection system 10 places the projection of an image 5, which represents some form of information, advertisement or communication, onto the projection surface 25.

The projection device 20 of the image projection system 10 can include a rear projector although a front projector or an overhead projector may also be utilized. In the case of a rear projector, the projection device 20 can be positioned at almost any location behind the projection surface 25, including at ground level or above or below ground level, to project an image 5 that is viewed in its proper orientation when the viewer 15 is on an opposite side of the projection surface 25 as the projection device 20. The projection of image 5 can further be varied to invert the image 5 such that a viewer 15 may view the image 5 in its proper orientation when the viewer 15 is positioned on the same side of projection surface 25 as projection device 20.

The projection device 20 can be one of a wide technological variety, including but not limited to, liquid crystal display (LCD), laser projection display (LPD), cathode ray tube (CRT), digital light processing (DLP), liquid crystal on silicone (LCoS), light emitting diode (LED) or plasma devices. Specific brands of a suitable projection device 20 may include but are not limited to Texas Instruments, DLP Technologies, Barco Projection Systems, Epson, Hitachi, JVC, Kodak, NEC, Panasonic, Philips, Polaroid, Sanyo, Sharp, Sony and Toshiba. One particular projection device 20 is the Christie RoadRunner LX100, which is sold by Christie Digital Systems of Cypress, Calif. However, any projection device that provides a brightness on the order of 3,500 or greater ANSI lumens can be utilized in accordance with the features of the image projection system 10, as described herein.

The projection surface 25 may be existing game equipment that is utilized in association with the progress of a sporting event, such as a goal net used in connection with a football game or a soccer game. The projection surface 25 may also include the structure of the venue. The projection surface 25 shown in FIG. 1 is a conventional field goal net, which is typically suspended behind a goal post, such as in the case of a football field goal post. The projection surface 25 may also be attached to a moveable structure such as in the case of soccer goal net. Utilization of the existing equipment eliminates the need to modify the equipment utilized in association with the sport event and should not interfere with the progress of the event.

The projection surface 25 may further be any transparent material that is suitable for the projection of the image 5. Non-transparent or semi-transparent materials can also be used as the projection surface 25 in accordance with the features of the image projection system 10, such as a matte white vinyl material or a pearlescent, silver or glass bead material. The projection surface 25 may also be a portable screen, such as, for example, a Cinefold screen, sold by Draper, Inc. of Spiceland, Ind. Regardless of the material from which the projection surface 25 is constructed, the projection surface 25 should able to receive light from the projection device 20 in order to display an image 5 that may be observed by at least one viewer 15 located proximate to the image 5. Further, the material used as the projection surface 25 should be conformable, durable and interchangeably usable as a goal net. The material utilized for the projection surface 25 should have the strength to withstand the impact of a football, soccer ball or other game-played object. Likewise, the material of the projection surface 25 must readily change shape so that the travel of the football, soccer ball or other game-played object is not disrupted.

The projection device 20 of image projection system 10 presents information to at least one viewer 15 by projecting the image 5 onto the projection surface 25. The image 5 may include any suitable form of information, and can include data, video or graphics or any combination thereof. Further, the projection of the image 5 can be in any suitable format, including but not limited to, audio visual, NTSC, high-definition, wide screen, overhead, slide or motion picture. The format of the image 5 is generally three-dimensional and can be a hologram or a stereoscopic or multi-planar image. The image 5 can also be a volumetric or perspective display and the image 5 can be either static or dynamic. The purpose of the image 5 is to inform or otherwise communicate information to the viewer 15. The information can comprise a promotion, an advertisement, a publicity release or an offer. The information can warn, entertain, offer, educate, advertise, publicize, announce, promote or provide lost and found information. The aforementioned list is intended to be illustrative and not exhaustive of the type of information that may be the subject of the image 5.

FIG. 1 shows image projection system 10 displaying the image 5 to at least one viewer 15 of a football game at a stadium. It can be appreciated that image projection system 10 can be adapted for projecting an image 5 at any type of venue including, but not limited to, an amphitheater, a coliseum, a gymnasium, a hippodrome, an ice rink, a stadium, a track, an arena, a shopping mall, a showroom, a concert hall, or an auditorium. The subject of the event can be any form of entertainment, including but not limited to a sport event, such as a football game, a soccer game, a hockey match; a concert, a circus or carnival, an equestrian show, or a race. The viewer 15 is any individual that can observe the image 5, including but not limited to, any member of an audience, a spectator, an attendee, a customer, a patron, an observer, a participant, a player, a game official, venue employee or remote viewer.

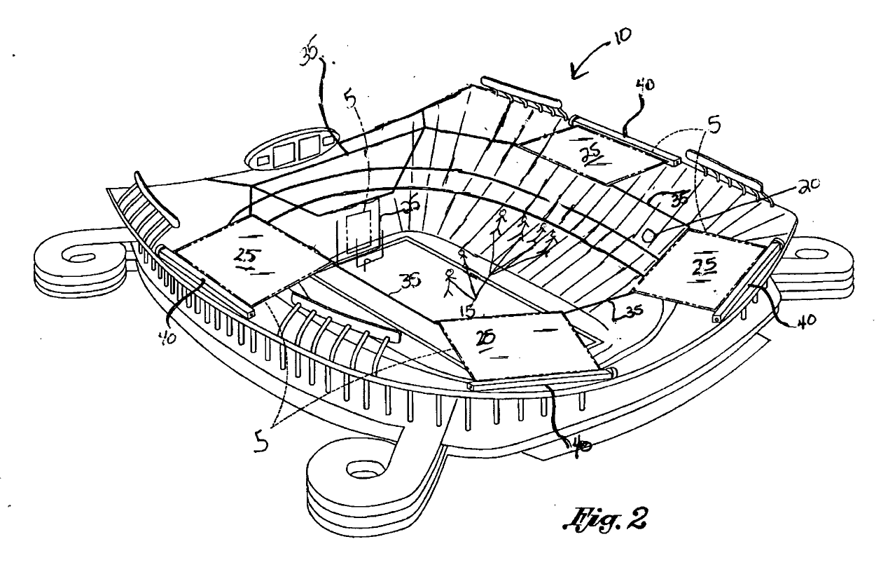

FIGS. 2-4 represent another embodiment of the image projection system 10 which shows the image projection system 10 as having one or more projection surfaces 25 that may be suspended from the structure of the venue by a suspension cable system 35. At least one projection surface 25 can be a weather protection screen to provide shelter from environmental conditions, such as a sunshade. Each projection surface 25 may also be any of the materials described with respect to FIG. 1 and should be large enough to provide a discernible image to at least one viewer 15. In this embodiment, projection device 20 may be either a rear projector or a front projector. Projection device 20 can be mounted anywhere within the venue in an appropriate position with respect to projection surface 25 and can utilize any of the aforementioned technology.

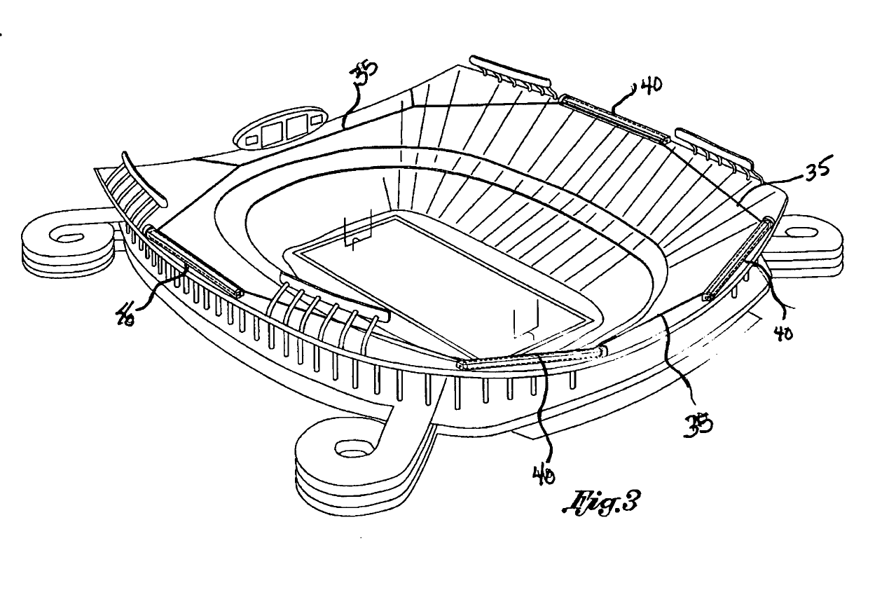

The suspension cable system 35 is comprised of at least one cable that is substantially coextensive with the perimeter of the top of the venue structure. Each projection surface 25 is connected to the suspension cable system 35 on a first end and a housing structure 40 on an opposite end. The housing structure 40 is preferably a rigid structure that partially or fully encloses the projection surface 25 in a stowed position and supports the projection surface 25 in its extended position. Each projection surface 25 is attached to a roller 46 contained within the housing structure 40, and each projection surface 25 can be extended or retracted from the roller 46 of the housing structure 40, either simultaneously or individually, FIG. 2 shows each projection surface 25 in the extended position and FIG. 3 shows each projection surfaces 25 in the stowed retracted position.

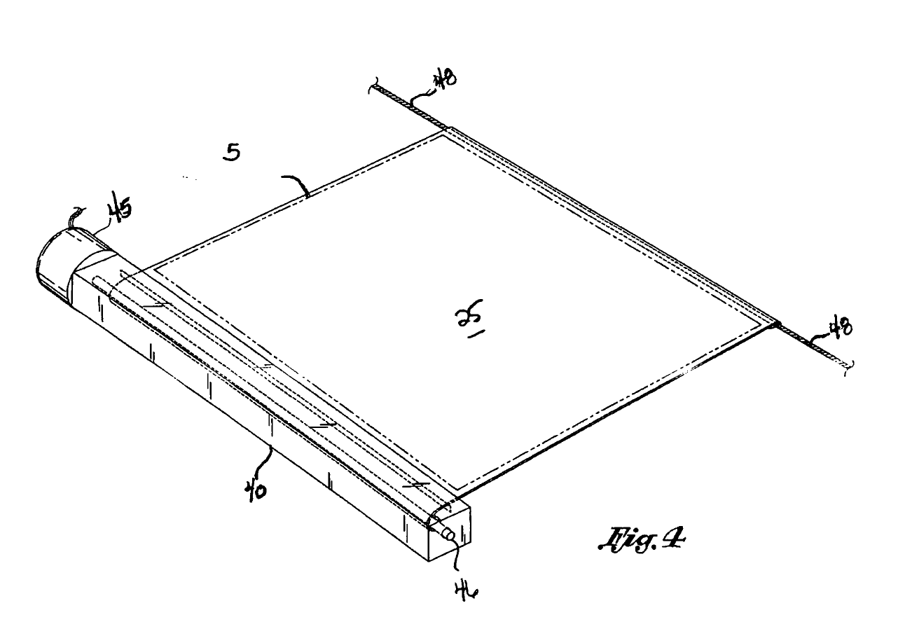

FIG. 4 illustrates a projection surface 25 attached to a housing structure 40 on one end and a cable 48 of the cable suspension system on an opposite end. The projection surfaces 25 may be extended or retracted using a power source 45 which may power a non-detachable drive motor incorporated into the housing structure 40. The power source 45 can also be a removable hand-held, cordless, motor driven apparatus; a detachable manual hand crank, such as a winch; or an electrically powered detachable power source. Only one power source 45 may be required to extend or retract each projection surface 25 simultaneously or a separate power source 45 may be used in connection with each projection surface 25 to individually extend or retract the same.

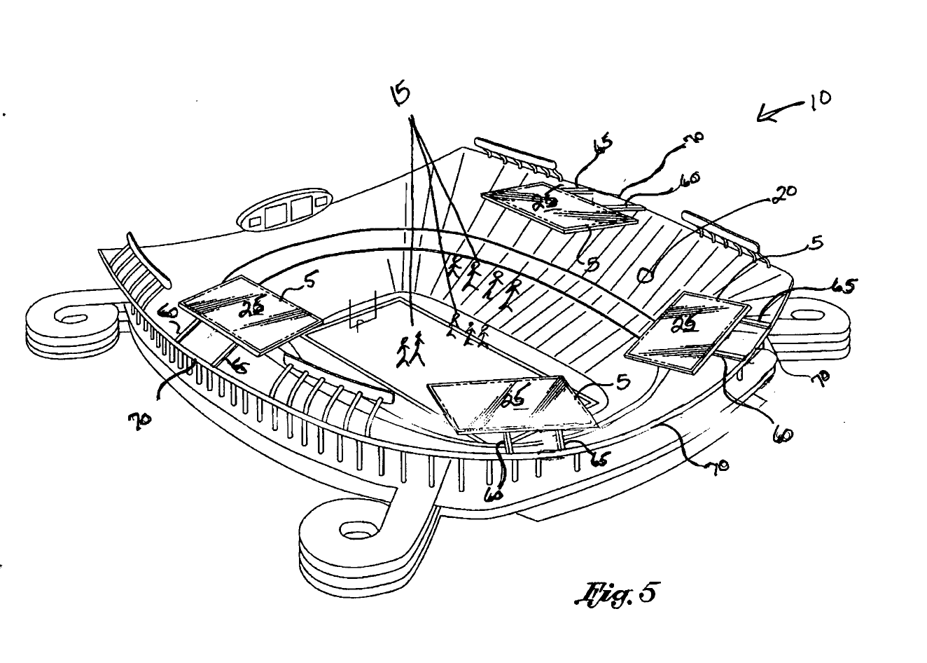

FIG. 5 represents another embodiment of the image projection system 10, having one or more projection surfaces 25 either permanently or removeably affixed to a pre-existing display structure or a fixed surface 70. The projection surface 25 may again be a weather protection screen. The projection surface 25 may be supported by a first support pole 60 and a second support pole 65. Support poles 60, 65 may be parallel to each other and equal in length. Support poles 60, 65 may be a component of an established, pre-existing display structure or support poles 60, 65 can be rigidly attached to any fixed surface, such as the venue structure 70, using conventional mounting hardware. Support poles 60, 65 can be constructed from any sturdy material having the strength to support the projection surface 25. The number and placement of projection surfaces 25 may be dependent on the architecture of the venue. The projection surface 25 may be extendable and retractable in connection with a housing as described with respect to FIGS. 2-4 or projection surface 25 may be in a fixed position. If the projection surface 25 is extendable and retractable, any of the power sources (not shown) described herein may be utilized. As will be apparent to those of ordinary skill in the art, the angle of inclination of the projection surface 25 may be varied in accordance with alternate preferences of viewing the projected image 5.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. An image projection system for displaying information for observation by at least one viewer of an event in a venue by projecting the information onto a venue structure or a game associated object, the image projection system comprising:
a projection device;
an image projected by the projection device for observation by the viewer, and
at least one projection surface on which the image is projected.

2. The image projection system of claim 1, wherein the projection device is one of a rear projector, a front projector and an overhead projector.

3. The image projection system of claim 1, wherein the projection device is one of a liquid crystal display, a laser projection display, a cathode ray tube, a digital light processing, a liquid crystal on silicone device, a light emitting diode device and a plasma device.

4. The image projection system of claim 1, wherein the image is a three dimensional image.

5. The image projection system of claim 4, wherein the image is a hologram.

6. The image projection system of claim 1, wherein the image is dynamic.

7. The image projection system of claim 1, wherein the projection surface is a goal net.

8. The image projection system of claim 1, wherein the projection surface is the venue structure.

9. The image projection system of claim 1, further comprising a suspension cable system from which the projection surface is suspended.

10. The image projection system of claim 9, wherein the suspension cable system further comprises at least one cable that is substantially coextensive with the perimeter of the top of the venue structure.

11. The image projection system of claim 1, further comprising a housing structure that encloses the projection surface in a stowed position and supports the projection surface in an extended position.

12. The image projection system of claim 1, further comprising a drive motor operative to extend the projection surface to an extended position and retract the projection surface to a stowed position.

13. The image projection surface of claim 12, further comprising a power source operative to power the drive motor.

14. The image projection system of claim 1, wherein the projection surface is a weather protection screen.
